(19) United States
(12) Patent Application Publication
(10) Pub. No.: US 2007/0288296 A1
(43) Pub. Date: Dec. 13, 2007

(54) System and method for automatic placement of products within shelving areas using a planogram with two-dimensional sequencing

(76) Inventor: Graham Lewis, Sherston (GB)

Correspondence Address: QUARLES & BRADY LLP, RENAISSANCE ONE, TWO NORTH CENTRAL AVENUE, PHOENIX, AZ, 85004-2391, US

(21) Appl. No.: 11/429,328

(22) Filed: May 5, 2006

(51) Int. Cl. G06F 17/30

(52) U.S. Cl. 705/10

(57) ABSTRACT

A computer implemented method generates a planogram for product placement on retail shelving. An initial arrangement of products is provided in a two-dimensional grid structure corresponding to a physical merchandising block. The grid structure is normalized based on physical aspects of products. A plurality of logical fixture blocks is provided within the merchandising block. A prioritized list of products is generated from a normalized grid structure. The prioritized list of products has at least two levels of prioritization with respect to each fixture block. The products from the prioritized list are placed into the fixture blocks. The final arrangement of products within the fixture blocks is scored to determine optimal placement of products. The planogram is executed and scored for every combination of products from the prioritization list. The optimal placement of products involves selecting an optimal score in terms of product placement.

### FIELD OF THE INVENTION

The present invention relates in general to placement of products on shelves within a retail outlet and, more particularly, to a system and method for automatic placement of products within shelving areas using a planogram with two-dimensional sequencing.

### BACKGROUND OF THE INVENTION

Retail stores are concerned with the placement of products on shelving areas. Retailers expend great time and effort in considering where and how to place products on the limited store shelves. The profitability of the store is in part dependent on an optimal placement of products for perusal by customers. If the customer cannot find a product, or a product does not catch his or her eye, or if there is insufficient stock on the shelf to meet demand, then a sale may be lost. Retailers must make products available, appealing, and easy to find in order to maximize sales. Merchandising, in the sense of product placement, must be continuously updated with shifts in consumer buying habits, seasonal rotation, and new product offerings.

Manufacturers and distributors compete intensely for desirable shelving locations and maximum facings (number of rows of product facing the customer). Retailers are careful to place high-volume, high-profit-margin products in preferred locations, i.e., front of store, end of aisles, and eye-level shelves. With finite shelving area, each product must be allocated some number of facings to satisfy consumer demand, minimize shelf-stocking labor, and maximize visible exposure. The process of maximizing sales and profitability, given the constraints of limited shelving area and competition among suppliers for the best shelves and facings, is a very difficult, yet important issue for retailers.

A major space-management problem facing retailers and suppliers today is poor implementation of merchandising plans and an inability to react quickly to changes in consumer demand with revised shelf layouts. A planogram is a product-placement layout, generated by a planning tool or computer program, which defines where products will be placed on the available store shelves, both in terms of shelf location and number of facings. Large retail chains routinely generate global or cluster planograms for local stores to implement. However, such generic planograms, which are designed to be shared across several stores, often do not accurately reflect the specific in-store fixture equipment, i.e., store shelving areas or local customer demand for products. The global planogram may not work within the physical architecture of the local store. The variability of shelving areas between different stores often requires manual modification of the layout by the person stacking the shelf, in order to make everything fit. Such manual modifications defeat the purpose of the generic planogram and make the store noncompliant with its corporate merchandising plan.

Historically, planograms have been done manually, often using an existing merchandise planogram as a template. The planogram designer starts with the existing planogram and then makes the necessary changes to accommodate the new shelving format and/or product placement. Other automated techniques divide the products into logical groups and then put products in sequence from top to bottom, snaking left to right across each shelf within defined horizontal limits. However, if the fixture types or configurations vary too much between the planogram to be populated and the template, the template effectively becomes unusable. A new planogram has to be created, which defeats the purpose of the template; i.e., in reality the planogram must be started from the beginning.

Another approach involves creating a planogram that uses a one-dimensional list of products, which is then flowed into the planogram zone in a predefined way. For example, brand sequencing may be done from left to right or size sequencing may be done from top to bottom. In this planogram layout scheme, if there are too many products to fit on a given shelf, then one or more products from the end of the shelf are assigned to the next shelf down. However, some retailers prefer to see certain products vertically blocked, i.e., related products vertically lined up for brand recognition. Rather than moving products from the end of the shelf, products should be moved from the middle of the shelf down to the next shelf to maintain the vertical blocking effect. A planogram that requires products from the end of the shelf to be moved down to the next shelf does not work where vertical blocking is preferred.

Retailers continuously look for a competitive edge. A significant opportunity lays in the ability to customize the configuration of products and shelf layout to be more targeted to the particular store, its local specifications, and fluctuations in consumer demand. A need exists to readily generate planograms for product placement that are customized to the needs of each particular retail store.

### SUMMARY OF THE INVENTION

In one embodiment, the present invention is a computer-implemented method of generating a planogram for product placement on retail shelving comprising the steps of providing an initial arrangement of products in a two-dimensional grid structure corresponding to a physical merchandising block, normalizing the two-dimensional grid structure based on physical aspects of products, providing a plurality of logical fixture blocks within the merchandising block, creating a prioritized list of products from the normalized grid structure, placing the products from the prioritized list into one of the fixture blocks, and scoring final arrangement of products within the plurality of fixture blocks to determine optimal placement of products.

In another embodiment, the present invention is a computer-implemented method of generating a planogram for product placement on retail shelving comprising the steps of providing a two-dimensional grid structure of products corresponding to a physical merchandising block, providing a plurality of logical fixture blocks within the merchandising block, creating a prioritized list of products from the grid structure, placing the products from the prioritized list into one of the fixture blocks, and scoring final arrangement of products within the plurality of fixture blocks to determine optimal placement of products.

In another embodiment, the present invention is a method of generating planograms for product placement on shelving comprising the steps of providing a two-dimensional grid structure of products, creating a prioritized list of products from the grid structure, providing placement for each of a plurality of combinations of products from the prioritized list into an area representing shelving, each combination of products being different from any other combination of products, scoring each configuration of the multiple combinations of products within the area representing shelving, and determining optimal placement of products by selecting an optimal score in terms of product placement from the plurality of combinations of products from the prioritization list.

In another embodiment, the present invention is a computer program product, usable with a programmable computer processor, having a computer-readable program code embodied therein, comprising computer-readable program code which provides a two-dimensional grid structure of products corresponding to a physical merchandising block, provides a plurality of logical fixture blocks within the merchandising block, creates a prioritized list of products from the grid structure, places the products from the prioritized list into one of the fixture blocks, and scores final arrangement of products within the plurality of fixture blocks to determine optimal placement of products.

In another embodiment, the present invention is a computer system for providing a model of customer response comprising means for providing a two-dimensional grid structure of products, corresponding to a physical merchandising block, means for providing a plurality of logical fixture blocks within the merchandising block, means for creating a prioritized list of products from the grid structure, means for placing the products from the prioritized list into one of the fixture blocks, and means for scoring final arrangement of products within the plurality of fixture blocks to determine optimal placement of products.

### BRIEF DESCRIPTION OF THE DRAWINGS

FIG. 1 is a block diagram illustrating the use of a planogram-generation tool for product placement on retail shelving;

FIG. 2 is a two-dimensional grid structure for initial product placement;

FIG. 3 is a two-dimensional grid structure normalized for product size and product facings;

FIG. 4 illustrates logical fixture blocks within a merchandising block;

FIG. 5 illustrates products being prioritized in a candidate list by distance from a fixture block;

FIG. 6 is a computer system for executing the planogram algorithm; and

FIG. 7 illustrates the steps of generating a planogram for optimal product placement on retail shelving.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Retail stores are interested in optimizing the placement of products on shelving areas. The profitability of the store is in part dependent on an optimal placement of products for perusal by customers. If the customer cannot find a product, or a product does not catch his or her eye, or if there is insufficient stock on the shelf to meet demand, then a sale may be lost. Retailers must make products available, appealing, and easy to find in order to maximize sales. Merchandising, in the sense of product placement, must be continuously updated with shifts in consumer buying habits, seasonal rotation, and new product offerings.

Manufacturers and distributors compete intensely for desirable shelving locations and maximum facings. Retailers typically place high-volume, high-profit-margin products in preferred locations, i.e., front of store, end of aisles, and eye-level shelves. With finite shelving area, each product must be allocated some number of facings. The goal of maximizing sales and profitability, with the constraints of limited shelving area and competition among suppliers for the best shelves and facings, makes the process of optimizing product placement difficult to achieve.

The present merchandising system uses planograms to design optimal product placement on retail store shelves. A planogram is a graphical representation of a retailer's shelving area, generated within a computer program. The planogram generates a product layout, or map, including shelf location and product facings, that is optimized to predetermined criteria. The optimum product-placement algorithm will take into account product size, number of product facings, use of shelf space, and similarity of final arrangement to the initial layout. The planogram will be easy for the local store to follow, as it is created with the store's unique shelving arrangement in mind.

Most, if not all, retail stores have variation in their shelving fixtures and arrangement. To avoid forcing a store to use a planogram that does not match its particular shelving arrangement, each store should have its own planogram which takes into account the unique features and resources of that store. This approach involves generating many planograms, one for each retail store, using an automated planogram-generation tool, i.e., using application software running on a computer system. The planogram-generation tool accepts the specifications of each store's shelving configuration, the list of products to be placed, a set of rules that defines the placement, and the sales goals for the store. The automatic generation of multiple planograms based on unique store specifications is part of the present merchandising methodology.

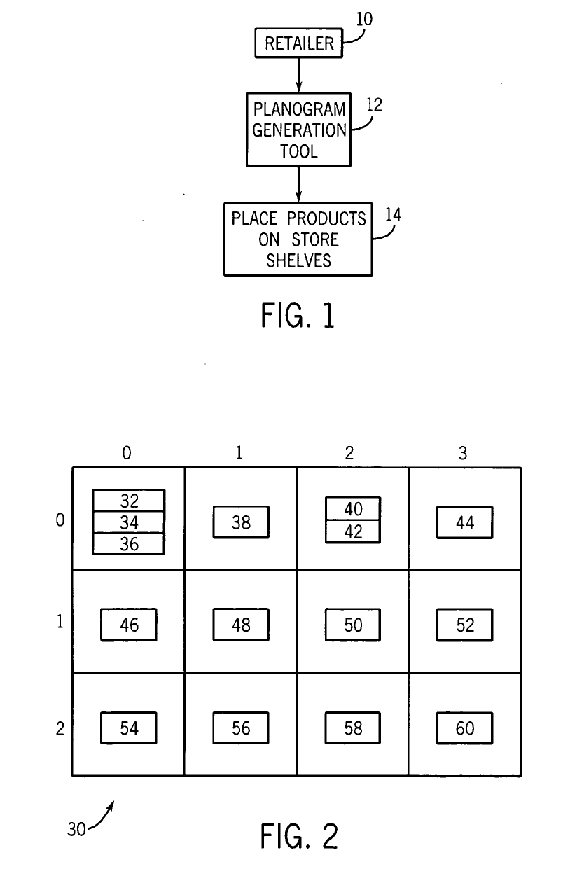

Referring to FIG. 1, retail outlet (retailer) 10 has certain product lines available to customers that need to be displayed in the store. Retailer 10 may be a food store chain, general products retailer, drug store, clothing store, discount warehouse, department store, specialty store, etc. Retailer 10 desires to organize the presentation of products for optimal sales and profitability. The management team of retailer 10 is held accountable for market share, profits, and overall success and growth of the business. While the present discussion will center on retailer 10, it is understood that the automated planogram-generation tool described herein is applicable to other industries and businesses having similar goals, constraints, and needs.

An automated planogram-generation tool 12 compiles a list of products to be displayed on the store shelves. The planogram uses store-specific physical constraints to generate an optimal product layout. The final planogram output is a stocking list and/or a drawing or photograph of stocked shelves in accordance with the optimal placement of products. A planogram is generated for each retail store given its unique shelving arrangement, product assortment, and customer demand. In block 14, the local retail store then uses the optimized, store-specific planogram to place the products on its shelves.

The available shelf space within a specific retail store can be determined by manual measurement. A store will have a certain number of aisles. Each aisle will have shelving on one or both sides. There will be a certain number of shelves vertically, which can vary along the aisles. The shelving can also vary in depth. All physical dimensions can be measured and calculated to create a detailed map of the available store shelving space. Each retail store will most likely be different and will require a unique specification for the shelving layout, or map. The shelf space may change with new fixtures or remodeling. Updated measurements can be taken at any time to maintain an accurate base shelving map for each retail store.

The automated planogram-generation tool 12 involves a sequence of steps that is repeated until an optimal solution is found. Each iteration involves placing product by predetermined rules and then evaluating the layout. Each iteration uses a different product placement and results in a different layout and evaluation. The optimal product-placement solution is determined by comparing the evaluations, or scores, of each iteration with respect to the others to find the best score, i.e., the most effective product layout.

The planogram algorithm begins with retailer 10 making an initial product-placement decision. The initial placement criteria can be based on subjective merchandising rules and considerations such as esthetics, easy visibility and access for the consumer, showcasing high-profit-margin item (front of store, end aisles, eye-level), and keeping blocks of similar products or same-branded products together. Other placement principles include product features, size, specials, advertising, promotions, and merchandising. For example, the retailer may want to keep same-branded products together and arrange products from top to bottom in increasing package size.

Next, retailer 10 sets a number of facings for each product to be displayed. The determination of the number of facings involves several factors that must be considered. Retailer 10 must consider the total number of products and the total shelving space. Product attributes such as size and form, as well as the height and depth of the shelf, must be taken into consideration so that the number of facings allows the shelf to hold at least 1.5 (or other retailer-specified number) cases of product. Retailer 10 desires to maintain some volume of product on the shelf at all times. The product can be allowed to sell down to 0.5 cases and then be restocked with one full case, without having to return a portion of the restock case to the back storage area. The number of facings also depends on the volume of sales and the delivery schedule. Most products should have sufficient facings so that the product does not sell out between deliveries. Most back storage areas do not have sufficient space to maintain backstock for each product on the sales floor. If delivery occurs once a week, then the number of facings should be sufficient to have product on the shelf for the week's sales. Finally, retailers often allow suppliers to purchase additional facings and/or optimal shelf locations for what is known as a “stocking fee.” If the supplier is willing to pay extra for more or better facings, this will be factored into the facings allocated for the product in the planogram.

Product size is determined by the manufacturer of the product and, depending on the product, will lend itself to some form of stacking. For example, a can of fruit will have a height and a diameter; a cereal box will have a length, a width, and a height; kitchen utensils hung on a pegboard will have associated dimensions. The physical size of each individual product is a known factor.

With the size of one product known, and the number of facings known, or the amount of product to be placed on the shelf known, the amount of shelving space required to contain the product can be readily determined. Again, the store-specific shelving area is also known. If the cereal box is 30 cm high by 20 cm wide by 5 cm deep, and 1.5 cases of product equates to 36 boxes of product, then the total volume of shelving space needed to display the product is the 3-dimensional size of one product times number of products to be placed on the shelf (30×20×5×36).

In FIG. 2, the process of placing products on store shelving begins by creating a list or table of products and assigning a horizontal and vertical sequence number to each product. Each product is assigned two sequence numbers: a horizontal sequence number and a vertical sequence number. Based on the horizontal and vertical sequence numbers, the products are distributed onto a two-dimensional grid structure. The horizontal numbering sequence 0, 1, 2, starts from the top and works down grid structure 30. The vertical numbering sequence 0, 1, 2, 3, . . . goes from left to right across grid structure 30. The two-dimensional grid structure defines the product placement for a merchandising block. The merchandising block represents a section of the total shelving in one aisle, which may be one 8-foot horizontal partition, including shelf space from top to bottom. The planogram algorithm treats each merchandising block independently.

In the present example, products 32, 34, 36, 38, 40, 42, 44, 46, 48, 50, 52, 54, 56, 58, and 60 are to be placed on the store shelving. Products 32-60 are assigned horizontal and vertical sequence numbers. The assignment of horizontal and vertical sequence number of each product can be done randomly or by considering where the store would ideally like to place each product based upon attributes of the product, such as brand, pack size, and flavor.

In the initial placement done by subjective merchandising criteria, products 32, 34, and 36 are placed together and assigned to cell 00 located at horizontal sequence 0 and vertical sequence 0. Product 38 is assigned to cell 01 located at horizontal sequence 0 and vertical sequence 1. Products 40 and 42 are placed together and assigned to cell 02 located at horizontal sequence 0 and vertical sequence 2. Product 44 is assigned to cell 03 located at horizontal sequence 0 and vertical sequence 3. Product 46 is assigned to cell 10 located at horizontal sequence 1 and vertical sequence 0. Product 48 is assigned to cell 11 located at horizontal sequence 1 and vertical sequence 1. Product 50 is assigned to cell 12 located at horizontal sequence 1 and vertical sequence 2. Product 52 is assigned to cell 13 located at horizontal sequence 1 and vertical sequence 3. Product 54 is assigned to cell 20 located at horizontal sequence 2 and vertical sequence 0. Product 56 is assigned to cell 21 located at horizontal sequence 2 and vertical sequence 1. Product 58 is assigned to cell 22 located at horizontal sequence 2 and vertical sequence 2. Finally, product 60 is assigned to cell 23 located at horizontal sequence 2 and vertical sequence 3. See Table 1 for a summary of the horizontal and vertical sequence numbers for each product.

TABLE 1

| | Horizontal, Vertical |
|---|---|
| Product | Sequence |
| 32 | 0, 0 |
| 34 | 0, 0 |
| 36 | 0, 0 |
| 38 | 0, 1 |
| 40 | 0, 2 |
| 42 | 0, 2 |
| 44 | 0, 3 |
| 46 | 1, 0 |
| 48 | 1, 1 |
| 50 | 1, 2 |
| 52 | 1, 3 |
| 54 | 2, 0 |
| 56 | 2, 1 |
| 58 | 2, 2 |
| 60 | 2, 3 |

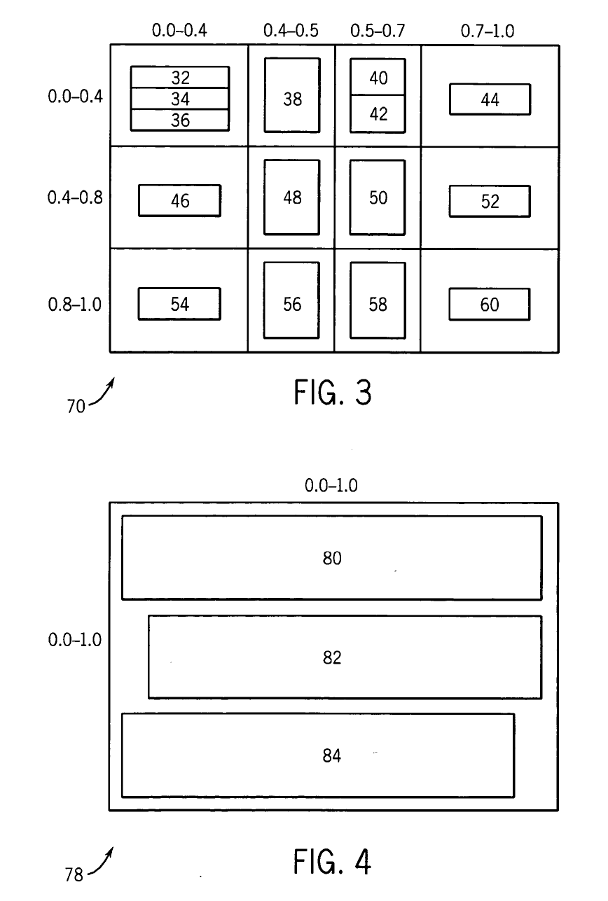

This initial product placement into grid structure 30 is translated into normalized space, taking into account the physical features of the products, number of proposed facings, and store-specific shelving constraints. The normalized grid structure 70 in FIG. 3 represents a measure of the physical space requirements for the given products and the number of proposed facings. Notice that the cells of grid structure 70 have been adjusted in size to accommodate the physical constraints of the products. For example, in horizontal sequence 0, products 32-36 are estimated to require 40% of the normalized space for the given shelf, as is true for product 38, products 40-42, and product 44. In horizontal sequence 1, product 46 is estimated to require 40% of the normalized space for the given shelf, as is true for product 48, product 50, and product 52. In horizontal sequence 2, product 54 is estimated to require 20% of the normalized space for the given shelf, as is true for product 56, product 58, and product 60.

In vertical sequence 0, products 32-36 are estimated to require 40% of the normalized space, as is true for products 46 and 54. In vertical sequence 1, product 38 is estimated to require 10% of the normalized space, as is true for products 48 and 56. In vertical sequence 2, products 40-42 are estimated to require 20% of the normalized space, as is true for products 50 and 58. In vertical sequence 3, product 44 is estimated to require 30% of the normalized space, as is true for products 52 and 60.

FIG. 3 represents an initial or original layout of the products 32-60 prior to any optimization, how the store manager might prefer to see the products placed, or at least a suggested starting point for the optimization process. Normalized grid structure 70 takes into account the physical constraints of the products, store-specific shelving configurations, and number of desired product facings. The initial layout may be done manually as described above or selected by the computer program according to predetermined parameters, such as giving preference for similar products being grouped together. As will be seen, the above estimates of space requirements may not be optimal or even accurate, but do provide a starting point for the planogram-generation tool 12.

Turning to FIG. 4, a scattering diagram 78 is used to illustrate the same merchandising block from FIGS. 2 and 3 logically organized into fixture blocks (FBs) 80, 82, and 84. A fixture block is a logical area of a shelf on which products will be placed. The fixture block can be any size, within the physical dimensions and limits of the merchandising block for a given retail store. The horizontal width of each fixture block is selected based on general product size, to provide a logical working space for the planogram algorithm. If the products are generally large, then a larger fixture block is selected. If the products are generally small, then a smaller fixture block is selected. In some cases, the fixture block spans the entire width of the merchandising block. In other cases, the fixture block may be less than the width of the merchandising block. In other embodiments, more than one fixture block can be placed adjacently along the horizontal or vertical space within the merchandising block. In FIG. 4, FB 82 and FB 84 are made slightly less than the horizontal space of the merchandising block.

To simplify the present example, assume one fixture block per shelf. The fixture blocks are associated with the group of products. Fixture block 80 is assigned a top shelf corresponding to horizontal sequence 0; fixture block 82 is placed in the area corresponding to horizontal sequence 1; fixture block 84 is placed in the area corresponding to horizontal sequence 2.

With respect to each fixture block, products are prioritized in order of preference for placement within a specific fixture block. The prioritization is assigned under product-selection rules established by the planogram designer. In one prioritization rule, any products left over from an above fixture block are given first priority in the next fixture block. In the case of FB 80 on the top shelf, there would be no products left over. However, in the case of FB 82, there may be products that could not be placed in FB 80 and would therefore be given first priority of placement in FB 82. A second grouping of products with the same prioritization level would be those products originally assigned to the grid structure cells corresponding to said fixture block. For FB 80, the second grouping would be products 32-44. For FB 82, the second grouping would be products 46-52. For FB 84, the second grouping would be products 54-60. The combination of any products left over from an above fixture block, and the products assigned to the grid structure cells corresponding to the fixture block, are designated as “selected” products. Any products that are not “selected” products, but that could be considered for placement in FB 80-84 are called “other” products. “Other” products include residual products that are located to the left, right, or below the subject fixture block. These “other” products are prioritized under the product-selection rules for placement in a particular fixture block lower than “selected” products.

The planogram algorithm uses the list of “selected” products and “other” products as candidates to be considered for placement in FB 80. The “selected” products for FB 80 are products 32-44 which are assigned to the grid structure cells corresponding to FB 80. “Other” products may include one or more of products 46-60 which are located below FB 80. The planogram places products 32-36 in FB 80. The physical dimensions of products 32-36 are known, as well as the number of facings for each. The normalized area of FB 80 is known. The planogram algorithm can readily determine the portion of FB 80 taken up by products 32-36. Next, product 38 is placed in FB 80 adjacent to products 32-36, if there is sufficient space available. Since the physical dimensions of product 38, the number of facings, and the normalized area of FB 80 is known, the planogram algorithm can readily determine the portion of FB 80 needed for product 38. If product 38 does not fit within the space available for FB 80, then it is marked as a “first priority selected” product for FB 82. Next, products 40-42 are placed in FB 80 adjacent to product 38, if there is sufficient space available. Since the physical dimensions of products 40-42, their number of facings, and the normalized area of FB 80 is known, the planogram algorithm can readily determine the portion of FB 80 needed for products 40-42. If products 40-42 do not fit within the space available for FB 80, then each is marked as a “first priority selected” product for FB 82. Finally, product 44 is placed in FB 80 adjacent to products 40-42, if there is sufficient space available. Since the physical dimensions of product 44, its number of facings, and the normalized area of FB 80 is known, the planogram algorithm can readily determine the portion of FB 80 needed for product 44. If product 44 does not fit within the space available for FB 80, then it is marked as a “first priority selected” product for FB 82. If there is any available space within FB 80 after placement of all “selected” products, then the planogram considers “other” products, e.g., one or more of products 44-60, for placement in FB 80.

For the present example, assume products 32-42 fit within FB 80, but product 44 did not fit within FB 80. The planogram algorithm next takes up FB 82. The list of “selected” products for FB 82 includes products 44, which did not fit in FB 80, and products 46-52, which are assigned to the grid structure cells corresponding to FB 82. “Other” products include one or more of products 54-60 which are located below FB 82. The planogram algorithm places product 44 in FB 82. The planogram algorithm can readily determine the portion of FB 82 taken up by product 44. Next, product 46 is placed in FB 82 adjacent to product 44, if there is sufficient space available. Since the physical dimensions of product 46, the number of facings, and the normalized area of FB 82 is known, the planogram algorithm can readily determine the portion of FB 82 needed for product 46. If product 46 does not fit within the space available for FB 82, then it is marked as a “first priority selected” product for FB 84. Next, product 48 is placed in FB 82 adjacent to product 46, if there is sufficient space available. Since the physical dimensions of product 48, its number of facings, and the normalized area of FB 82 is known, the planogram algorithm can readily determine the portion of FB 82 needed for product 48. If product 48 does not fit within the space available for FB 82, then it is marked as a “first priority selected” product for FB 84. Next, product 50 is placed in FB 82 adjacent to product 48, if there is sufficient space available. Since the physical dimensions of product 50, its number of facings, and the normalized area of FB 82 is known, the planogram algorithm can readily determine the portion of FB 82 needed for product 50. If product 50 does not fit within the space available for FB 82, then it is marked as a “first priority selected” product for FB 84. Finally, product 52 is placed in FB 82 adjacent to product 50, if there is sufficient space available. Since the physical dimensions of product 52, its number of facings, and the normalized area of FB 82 is known, the planogram algorithm can readily determine the portion of FB 82 needed for product 52. If product 52 does not fit within the space available for FB 82, then it is marked as a “first priority selected” product for FB 84. If there is any available space within FB 82 after placement of all “selected” products, then the planogram considers “other” products, e.g., one or more of products 54-60, for placement in FB 82.

Assume products 44-50 fit within FB 82, but product 52 did not fit within FB 82. The planogram algorithm next takes up FB 84. The list of “selected” products for FB 84 includes product 52, which did not fit in FB 82, and products 54-60, which are assigned to the grid structure cells corresponding to FB 84. The planogram algorithm places product 52 in FB 84. The planogram algorithm can readily determine the portion of FB 84 taken up by product 52. Next, product 54 is placed in FB 84 adjacent to product 52, if there is sufficient space available. Since the physical dimensions of product 54, its number of facings, and the normalized area of FB 84 is known, the planogram algorithm can readily determine the portion of FB 84 needed for product 54. If product 54 does not fit within the space available for FB 84, then it is marked as a “first priority selected” product for another fixture block. Next, product 56 is placed in FB 84 adjacent to product 54, if there is sufficient space available. Since the physical dimensions of product 56, its number of facings, and the normalized area of FB 84 is known, the planogram algorithm can readily determine the portion of FB 84 needed for product 56. If product 56 does not fit within the space available for FB 84, then it is marked as a “first priority selected” product for another fixture block. Next, product 58 is placed in FB 84 adjacent to product 56, if there is sufficient space available. Since the physical dimensions of product 58, its number of facings, and the normalized area of FB 84 is known, the planogram algorithm can readily determine the portion of FB 84 needed for product 58. If product 58 does not fit within the space available for FB 84, then it is marked as a “first priority selected” product for another fixture block. Finally, product 60 is placed in FB 84 adjacent to product 58, if there is sufficient space available. Since the physical dimensions of product 60, its number of facings, and the normalized area of FB 84 is known, the planogram algorithm can readily determine the portion of FB 84 needed for product 60. If product 60 does not fit within the space available for FB 84, then it is marked as a “first priority selected” product for another fixture block.

Once the merchandising block is full, a scoring is done to determine how well the planogram algorithm fit the products into the available shelf space. The layout scoring looks at criteria such as products left over on the candidate list, unused space within a fixture block, and similarity of final product placement to the initial layout in FIG. 2. Scoring may be done by measuring how closely the final product placement approximates the initial product placement. Scoring may reflect a penalty for unallocated shelf space, i.e., product placement did not completely fill available shelf space. Scoring may reflect a penalty for insufficient shelf space, i.e., product still left on candidate list after merchandising block is filled. A high score indicates an effective planogram layout, in that the products from the candidate list were placed in relatively close juxtaposition to their original preferred layout and substantially filled the merchandising block. In an ideal layout, there should be no products left over on the candidate list, the products should have the desired number of facings and exactly fill the fixture blocks, and the product placement should not be substantially dissimilar from the initial preferred product layout. A low score indicates an ineffective planogram layout, i.e., products left over on the candidate list, unused space within a fixture block, and final product placement substantially different from the initial layout.

If the score is low, the planogram is run again to alter the product placement in the fixture block(s) to increase the layout score. The second planogram run will make changes to the product placement in an attempt to find a better solution, i.e., one that provides more effective placement of products on the store shelf. The changes to product placement may involve placing products in a different order on the candidate list. The second planogram run may also change the number of product facings to alter the overall layout. The shelf placement or fixture block size may also be changed if necessary. The products are placed again as described above, and the scoring is repeated. Since the planogram algorithm is being performed within a computer system, the process of placing product, scoring the layout, and making changes can be repeated any number of times in rapid execution, as the work is being done in virtual space in the computer's memory. Although the previous example placed products in the order from the grid structure, the planogram algorithm can readily change this order. For example, product 38 may be placed before products 32-36, product 44 may be placed before products 40-42, and so on. The planogram algorithm may be executed for each possible combination of product placement, which may involve hundreds, or thousands, of execution cycles. The scoring is performed for each execution cycle to find the optimal score and product placement.

Consider an alternate embodiment of the planogram algorithm wherein the candidate list is expanded to include more products than can fit in the fixture block or merchandising block. For example, the candidate list may be expanded to include twice as many products as can fit in the fixture block, i.e., enough products to fill twice the available space. This larger candidate list provides more products to test placement and optimize the layout. Again, the products on the candidate list are prioritized for placement. In the present discussion, the prioritization has two levels: “selected” and “other,” although the algorithm can be readily adapted to use additional prioritization levels.

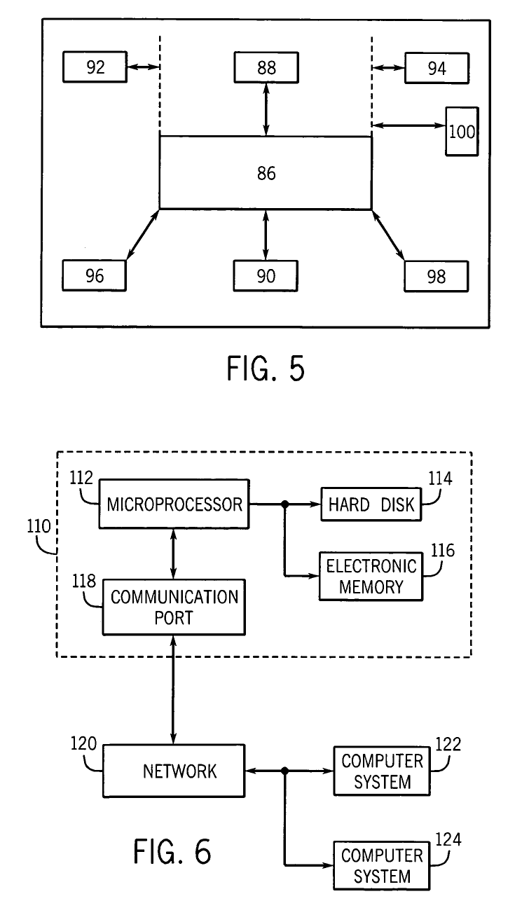

FIG. 5 illustrates placement of products from the prioritized candidate list into fixture block 86. The prioritized candidate list includes “first level of priority” products 88, designated as “selected” products, from a fixture block above FB 86. The prioritized candidate list further includes additional “selected” products that are slated for placement within FB 86 from the initial product layout. The prioritized candidate list includes “second level of priority” products, designated as “other” products. The “other” products are taken from areas below or to the side of FB 86. The “other” products are taken in order of (1) products below FB 86, and (2) products least distant to the side of FB 86. Product 90 is located below FB 86 and added to the prioritized candidate list. Product 92 is located to the upper left of FB 86 and has the least distance to FB 86; product 94 is located to the upper right of FB 86 and has the second least distance to FB 86; product 96 is located to the lower left of FB 86 and has the third least distance to FB 86; product 98 is located to the lower right of FB 86 and has the fourth least distance to FB 86; product 100 is located to the upper right of FB 86 and has the fifth least distance to FB 86. The distance can be measured horizontally or diagonally by design choice. For example, products above the fixture block can be measured horizontally to the nearest vertical edge, while products below are measured diagonally to any part of the fixture block. Products 92-100 are added as “second level priority” products to the candidate list until the list contains approximately twice as many products as will fit within FB 86.

Products from the candidate list are placed in FB 86 by order of priority. Once the fixture blocks within the merchandising block are filled, the layout is scored as described above, i.e., by factoring in “selected” products left over on the candidate list, unused space within the fixture block, similarity of final product placement to the initial layout, and proximity of unable-to-be-placed product to that fixture block. The score is then recorded.

The placement process is repeated for all possible combinations of products from the candidate list. In other words, each possible ordering or combination of products is placed and the resulting layout is tested for its overall effectiveness. For each test-run, the candidate list is generated, products are placed in the fixture blocks from the prioritized list, and the list is continually updated with more “selected” and “other” products to include enough products to fill twice the available space. For example, a first combination of products is placed in the fixture blocks in a first order using the planogram algorithm, e.g., a first “selected” product is placed first in FB 86, and a second “selected” product is placed second in FB 86, and so on. Once the products are placed, the scoring is then performed and recorded.

Next, a second combination of products is tested using the planogram algorithm. The second combination may be a second group of products, or a second ordering of the first group of products. For the second combination test-run, the second “selected” product is placed first in FB 86 and a first “selected” product is placed second in FB 86. The remaining “selected” products can also be interchanged with respect to the first combination as well. The same mixing occurs for products from the “other” priority level. The bottom line is that each test-run places a different combination of products from the prioritized candidate list into FB 86. Again, all possible combinations of products from the prioritized candidate list are tested and scored. Any combination that requires more than the available space within the merchandising block can be discarded as unworkable. The combination that returns the best score for the present merchandising block is chosen as the optimal placement of products for the planogram algorithm.

The above process has placed products within one merchandising block, e.g., within one 8-foot section of shelving. The product layout is assigned using a two-dimensional grid structure that accounts for horizontal and vertical deviations and corrections in product placement. The placement of products is considered optimal when the overall placement, taking into account the horizontal and vertical variables, has achieved the best (highest) score, i.e., the most effective and efficient placement of products. The planogram process is repeated for the next merchandising block, excluding products that have already been placed in a previous merchandising block.

The planogram algorithm will generate a stocking list and a drawing or photograph of a stocked shelf in accordance with the optimal combination and configuration of products. A planogram is generated for each retail store given its unique shelving arrangement, list of products, and customer demand. The automated capability of the planogram algorithm allows multiple layouts to be readily generated, and customized to each retail outlet. The automated capability arises from the fact that the present planogram is executed as application software on a computer system.

FIG. 6 illustrates a simplified computer system 110 for executing the software program used in the planogram-generation tool 12. Computer system 110 is a general-purpose computer including a central processing unit or microprocessor 112, mass storage device or hard disk 114, electronic memory 116, and communication port 118. Communication port 118 represents a modem, high-speed Ethernet link, or other electronic connection to transmit and receive input/output (I/O) data with respect to other computer systems.

Computer 110 is shown connected to communication network 120 by way of communication port 118. Communication network 120 can be a local and secure communication network such as an Ethernet network, global secure network, or open architecture such as the Internet. Computer systems 122 and 124 can be configured as shown for computer 110 or dedicated and secure data terminals. Computers 122 and 124 are also connected to communication network 120. Computers 110, 122, and 124 transmit and receive information and data over communication network 120.

When used as a standalone unit, computer 110 can be located in any convenient location. When used as part of a computer network, computers 110, 122, and 124 can be physically located in any location with access to a modem or communication link to network 120. For example, computer 110 can be located in the main office of retailer 10. Computer 122 can be located in one retail store. Computer 124 can be located in another retail store. Alternatively, the computers can be mobile and follow the users to any convenient location, e.g., remote offices, customer locations, hotel rooms, residences, vehicles, public places, or other locales with electronic access to communication network 120.

Each of the computers runs application software and computer programs which can be used to display user-interface screens, execute the functionality, and provide the features of the aforedescribed planogram algorithm. In one embodiment, the screens and functionality come from the application software, i.e., the planogram-generation program runs directly on one of the computer systems. Alternatively, the screens and functionality can be provided remotely from one or more websites on the Internet. In this case, the local computer is a portal to the planogram-generation program running on a remote computer. The websites are generally restricted-access and require passwords or other authorization for accessibility. Communications through such websites may be encrypted using secure encryption algorithms. Alternatively, the screens and functionality are accessible only on the secure private network, such as Virtual Private Network (VPN), with proper authorization.

The software is originally provided on computer-readable media, such as compact disks (CDs), magnetic tape, or other mass storage medium. Alternatively, the software is downloaded from electronic links such as the host or vendor website. The software is installed onto the computer system hard drive 114 and/or electronic memory 116, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having a computer-readable program code embodied therein. The software contains one or more programming modules, subroutines, computer links, and compilations of executable code, which perform the functions of the planogram-generation tool. The user interacts with the software via keyboard, mouse, voice recognition, and other user-interface devices connected to the computer system.

The software stores information and data related to the planogram-generation tool in a database or file structure located on any one of, or combination of, hard drives 114 of the computers 110, 122, and/or 124. More generally, the information used in the planogram-generation tool can be stored on any mass storage device accessible to computers 110, 122, and/or 124. The mass storage device for storing the planogram-generation tool may be part of a distributed computer system.

In the case of Internet-based websites, the interface screens are implemented as one or more webpages for receiving, viewing, and transmitting information related to the planogram-generation tool 12. A host service provider may set up and administer the website from computer 110 located in the retailer's home office. The employee accesses the webpages from computers 122 and 124 via communication network 120.

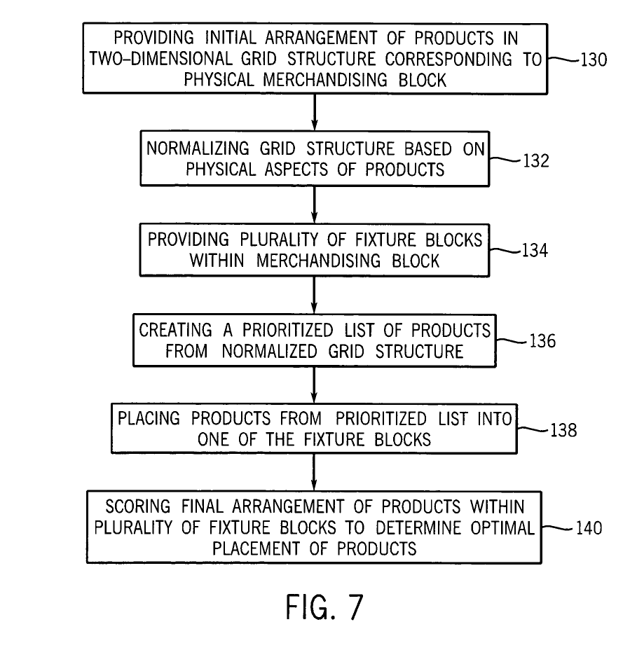

As further explanation, FIG. 7 illustrates a process flowchart of one embodiment of the planogram-generation tool 12 for product placement on retail shelving. In step 130, an initial arrangement of products is provided in a two-dimensional grid structure corresponding to a physical merchandising block. The initial arrangement of products in said two-dimensional grid structure involves consideration of subjective merchandising rules. In step 132, the two-dimensional grid structure is normalized based on physical aspects of products. The step of normalizing the two-dimensional grid structure involves consideration of product size and available product facings. In step 134, a plurality of logical fixture blocks is provided within a merchandising block. Each of the fixture blocks represents a logical portion of the merchandising block. In step 136, a prioritized list of products is generated from the normalized grid structure, as a plurality of logical fixture blocks is provided within the merchandising block. The prioritized list of products has at least two levels of prioritization with respect to a first fixture block. A first level of prioritization includes products from above the first fixture block and products assigned to the first fixture block in accordance with the normalized two-dimensional grid structure. A second level of prioritization includes products from below and to a side of the first fixture block. In step 138, the products from the prioritized list are placed into one of the fixture blocks. The prioritization list is updated with products to have at least twice as many products in the prioritized list as available shelf space. In step 140, the final arrangement of products within the plurality of fixture blocks is scored to determine optimal placement of products. The step of scoring the final arrangement of products within the plurality of fixture blocks involves taking into consideration such factors as number of products left over in the prioritized list, unused space within the merchandising block, similarity of the final product arrangement to the initial product arrangement, and proximity of unable-to-be-placed products to the fixture block. The planogram is executed for a plurality of combinations of products from the prioritization list, each execution of the planogram generating a score. The optimal placement of products involves selecting an optimal score in terms of product placement for the planograms executed for the plurality of combinations of products from the prioritization list.

One advantage of the present approach is that merchandising rules can be applied to a wide variety of fixture types and product offerings, such that the product positions generated will reflect an optimized solution, given both vertical and horizontal orientations and preferences. The product layout is assigned using a two-dimensional grid structure that accounts for horizontal and vertical deviations and corrections in product placement. The products are placed by priority of the candidate list, and the resulting layout is scored. Each time the candidate list and/or placement rule is altered to obtain a different product placement. Again, the resulting layout is scored. The process is repeated for each possible combination of product placement. The placement of products is considered optimal when the overall placement, taking into account the horizontal and vertical variables, has achieved the best (highest) score, i.e., the most effective and efficient placement of products.

While one or more embodiments of the present invention has been illustrated in detail, the skilled artisan will appreciate that modifications and adaptations to those embodiments may be made without departing from the scope of the present invention as set forth in the following claims.

What is claimed is:

1. A computer implemented method of generating a planogram for product placement on retail shelving, comprising:
providing an initial arrangement of products in a two-dimensional grid structure corresponding to a physical merchandising block;
normalizing the two-dimensional grid structure based on physical aspects of products;
providing a plurality of logical fixture blocks within the merchandising block;
creating a prioritized list of products from the normalized grid structure;
placing the products from the prioritized list into one of the fixture blocks; and
scoring final arrangement of products within the plurality of fixture blocks to determine optimal placement of products.

2. The computer implemented method of claim 1, wherein the initial arrangement of products in the two-dimensional grid structure involves consideration of subjective merchandising rules.

3. The computer implemented method of claim 1, wherein normalizing the two-dimensional grid structure involves consideration of product size and product facings.

4. The computer implemented method of claim 1, wherein each of the fixture blocks represents a logical portion of the merchandising block.

5. The computer implemented method of claim 1, wherein the prioritized list of products has at least two levels of prioritization with respect to a first fixture block.

6. The computer implemented method of claim 5, wherein a first level of prioritization includes products from above the first fixture block and products assigned to the first fixture block in accordance with the normalized two-dimensional grid structure and a second level of prioritization includes products from below and to a side of the first fixture block.

7. The computer implemented method of claim 1, wherein scoring final arrangement of products within the plurality of fixture blocks involves consideration of at least one criteria selected from the group consisting of products left over in the prioritized list, unused space within the merchandising block, closeness of the final product arrangement to the initial product arrangement, and closeness of products to the fixture block.

8. The computer implemented method of claim 1, wherein the prioritization list is updated with products to have at least twice as many products in the prioritized list as available shelf space.

9. The computer implemented method of claim 1, wherein the planogram is executed for a plurality of combinations of products from the prioritization list, each execution of the planogram generating a score.

10. The computer implemented method of claim 9, wherein the optimal placement of products involves selecting an optimal score in terms of product placement for the planograms executed for the plurality of combinations of products from the prioritization list.

11. A computer implemented method of generating a planogram for product placement on retail shelving, comprising:
providing a two-dimensional grid structure of products corresponding to a physical merchandising block;
providing a plurality of logical fixture blocks within the merchandising block;
creating a prioritized list of products from the grid structure;
placing the products from the prioritized list into one of the fixture blocks; and
scoring final arrangement of products within the plurality of fixture blocks to determine optimal placement of products.

12. The computer implemented method of claim 11, wherein the two-dimensional grid structure involves consideration of product size and product facings.

13. The computer implemented method of claim 11, wherein the prioritized list of products has at least two levels of prioritization with respect to a first fixture block.

14. The computer implemented method of claim 11, wherein the prioritization list is updated with products to have at least twice as many products in the prioritized list as available shelf space.

15. The computer implemented method of claim 11, wherein the planogram is executed for a plurality of combinations of products from the prioritization list, each execution of the planogram generating a score.

16. The computer implemented method of claim 15, wherein the optimal placement of products involves selecting an optimal score in terms of product placement for the planograms executed for the plurality of combinations of products from the prioritization list.

17. A method of generating planograms for product placement on shelving, comprising:
providing a two-dimensional grid structure of products;
creating a prioritized list of the products from the grid structure;
providing placement for each of a plurality of combinations of products from the prioritized list into an area representing shelving, each combination of products being different from any other combination of products;
scoring each placement of the multiple combinations of products within the area representing shelving; and
determining optimal placement of products by selecting an optimal score in terms of product placement from the plurality of combinations of products from the prioritization list.

18. The method of claim 17, wherein the two-dimensional grid structure involves consideration of product size and product facings.

19. The method of claim 17, wherein the prioritized list of products has at least two levels of prioritization.

20. A computer program product usable with a programmable computer processor having a computer readable program code embodied therein, comprising:
computer readable program code which provides a two-dimensional grid structure of products corresponding to a physical merchandising block;
computer readable program code which provides a plurality of logical fixture blocks within the merchandising block;
computer readable program code which creates a prioritized list of products from the grid structure;
computer readable program code which places the products from the prioritized list into one of the fixture blocks; and
computer readable program code which scores final arrangement of products within the plurality of fixture blocks to determine optimal placement of products.

21. The computer program product of claim 20, wherein the prioritization list is updated with products to have at least twice as many products in the prioritized list as available shelf space within the merchandising block.

22. The computer program product of claim 20, wherein the planogram is executed for a plurality of combinations of products from the prioritization list, each execution of the planogram generating a score.

23. The computer program product of claim 22, wherein the optimal placement of products involves selecting an optimal score in terms of product placement for the planograms executed for the plurality of combinations of products from the prioritization list.

24. A computer system for providing a model of customer response, comprising:
means for providing a two-dimensional grid structure of products corresponding to a physical merchandising block;
means for providing a plurality of logical fixture blocks within the merchandising block;
means for creating a prioritized list of products from the grid structure;
means for placing the products from the prioritized list into one of the fixture blocks; and
means for scoring final arrangement of products within the plurality of fixture blocks to determine optimal placement of products.

25. The computer system of claim 24, wherein the prioritization list is updated with products to have more products in the prioritized list as available shelf space within the merchandising block.

26. The computer system of claim 24, wherein the planogram is executed for a plurality of combinations of products from the prioritization list, each execution of the planogram generating a score.

27. The computer system of claim 26, wherein the optimal placement of products involves selecting an optimal score in terms of product placement for the planograms executed for the plurality of combinations of products from the prioritization list.
